(19) United States
(12) Patent Application Publication
(10) Pub. No.: US 2021/0334264 A1
(43) Pub. Date: Oct. 28, 2021

(54) SYSTEM, METHOD, AND PROGRAM FOR INCREASING EFFICIENCY OF DATABASE QUERIES

(71) Applicant: Kohei KAIGAI, Tokyo (JP)

(72) Inventor: Kohei KAIGAI, Tokyo (JP)

(21) Appl. No.: 17/299,943

(22) PCT Filed: Dec. 9, 2018
(86) PCT No.: PCT/JP2018/045197

§ 371 Date: Jun. 4, 2021

(51) Int. Cl. G06F 16/23; G06F 16/25; G06F 16/2453; G06F 13/40; G06F 13/42

(52) U.S. Cl. CPC G06F 16/2308; G06F 16/252; G06F 2213/0026; G06F 13/4022; G06F 13/4221; G06F 16/2453

(57) ABSTRACT

[Problem] To provide a device, a method, and a program for speeding up a database process which can be implemented at a low cost. [Solution] A plurality of I/O extension units including a GPU, an SSD and a PCIe switch are connected to a database server via a PCIe bus, and it is made possible to transfer data from the SSD to the GPU and perform processing in parallel without the intervention of a CPU and a main memory. In a preprocess of a database query, it is made possible to generate an instruction for the process of a large amount of data to be completed within one I/O extension unit and execute a database query without the intervention of the CPU and the main memory. When necessary, an SQL execution plan is dynamically rewritten in accordance with a hardware configuration.

### TECHNICAL FIELD

The present disclosure generally relates to a system, method, and program for improving the efficiency of query processing on a database, and in particular to a system, method, and program for improving the efficiency using a Graphic Processing Unit (GPU) and Peer-to-Peer Direct Memory Access (P2P DMA).

### BACKGROUND ART

Database Management Systems (DBMS), especially Relational Database Management Systems (RDBMS), have become an indispensable component of today's information systems. Therefore, speeding up the processing of RDBMS is very important to improve the efficiency of the entire information system, and many performance acceleration techniques have been proposed.

One such acceleration technique is the one using GPUs (e.g., Non-patent Document 1, Non-patent Document 2, and Patent Document 1). GPUs are a common component in today's personal computers and game consoles. While they are inexpensive and widely available, they are suitable for general-purpose applications in addition to graphics processing, since they are essentially parallel processors with many cores.

In conventional techniques for accelerating database access using GPUs, a performance bottleneck was in data movement from a secondary storage device to a main memory. In order to process data stored in the database on the secondary storage device, Central Processing Unit (CPU) first allocated a buffer area on the main memory, then loaded data from the secondary storage device such as an SSD (solid state drive) into the buffer, and only after this loading process is complete, the data stored in the secondary storage were able to be processed.

In today's hardware technology, a bandwidth between the CPU and the main memory is 50 GB to 300 GB per second, while a bandwidth of a peripheral bus connecting the CPU to the secondary storage is about 4 GB to 15 GB per second, making inevitably the latter a performance bottleneck. In conventional database processing techniques, a large amount of data had to be transferred through this bottleneck, which partially canceled out the performance improvement of parallel processing by GPUs. FIG. 1 shows a prior art configuration of a GPU-based database server. As mentioned above, when the GPU (104) accesses the SSD (103) via the CPU's built-in I/O controller (usually, PCIe Root Complex) (105), the data transfer path between the main memory (101) and the CPU (102) became a bottleneck and the efficiency of database query processing is hampered.

A technique (e.g., Patent Document 2) was proposed to solve this problem by bypassing the main memory as much as possible to improve the efficiency of database queries by GPUs. However, while performance requirement to database processing is increasing and performance of SSDs is improving, further efficiency improvements were required.

FIG. 2 shows a prior art configuration of a database server utilizing the GPU as disclosed in Patent Document 2. By utilizing P2P DMA and transferring data directly from a secondary storage device such as SSD (103) to a secondary computing device such as GPU (104) without going through the main memory, the efficiency was greatly improved compared to the system shown in FIG. 1. However, since the P2P DMA data transfer was controlled by the I/O controller (105) built in the CPU (101), there still is a problem that the CPU might become a new bottleneck.

### PRIOR ART DOCUMENTS

### Non-Patent Document

[Non-Patent Document 1]
GPUDirect RDMA (http://docs.nvidia.com/cuda/gpudirect-rdma/index.html)
[Non-Patent Document 2]
GPGPU Accelerates PostgreSQL (http://www.slideshare.net/kaigai/gpgpu-accelerates-postgresql)

### Patent Document

[Patent Document 1] PCT Publication WO/2015/105043
[Patent Document 2] Japan Patent 6381823

### SUMMARY OF THE INVENTION

### Problems to be Solved by the Invention

To provide a system, method, and program for improving the efficiency of database queries that can be implemented affordably.

### Means for Solving the Problems

The present invention solves the above problem by providing

a database processing apparatus comprising:
a first external storage device;
a first parallel processing device;
a first I/O switch;
a second external storage device;
a second parallel processing device;
a second I/O switch;
a central processing device;
an I/O controller which is built in the central processing unit or directly connected to the central processing unit via an internal bus; and
a main memory;

wherein the first external storage device, a first parallel processing device, and a first I/O switch are housed in a first enclosure;

the second external storage device, the second parallel processing device, and the second I/O switch are housed in a second enclosure;

the central processing unit and the I/O controller are housed in a third enclosure;

the first enclosure and the third enclosure are different;

the second enclosure and the third enclosure are different;

the central processing unit is configured to issue, to the first external storage device via the first I/O switch, an order for transferring data stored in the first external storage device to the first parallel processing device, without an intervention of the I/O controller or the main memory; and

the central processing unit is configured to issue, to the second external storage device via the second I/O switch, an order for transferring data stored in the second external storage device to the second parallel processing device, without an intervention of the I/O controller or the main memory.

Moreover, the present invention solves the above problem by providing

a database processing apparatus according to Paragraph 0011,

wherein the first external storage device, the first parallel processing device, the first I/O switch are housed in an off-the-shelf external I/O expansion unit.

Moreover, the present invention solves the above problem by providing

a database processing apparatus according to Paragraph 0011 or Paragraph 0012,

wherein the first I/O switch and the I/O controller is connected using a PCIe interface.

Moreover, the present invention solves the above problem by providing

a database processing apparatus according to Paragraph 0011 or Paragraph 0012,

wherein the first I/O switch and the I/O controller is connected using a network.

Moreover, the present invention solves the above problem by providing

a non-transitory computer readable medium that stores a computer-executable program for database processing,

the computer-executable program being executed on a database processing apparatus comprising:
a first external storage device;
a first parallel processing device;
a first I/O switch;
a second external storage device;
a second parallel processing device;
a second I/O switch;
a central processing unit;
an I/O controller which is built in the central processing unit or directly connected to the central processing unit via an internal bus; and
a main memory;
wherein the first external storage device, a first parallel processing device, and a first I/O switch are housed in a first enclosure;
   the second external storage device, the second parallel processing device and the second I/O switch are housed in a second enclosure;
   the central processing unit and the I/O controller are housed in a third enclosure;
   the first enclosure and the third enclosure are different;
   the second enclosure and the third enclosure are different, and the computer-executable program comprising instructions for:
ordering, to the first external storage device via the first I/O switch, to transfer data stored in the first external storage device to a first parallel processing device, without an intervention of the I/O controller or the main memory; and
ordering to the second external storage device via the second I/O switch, to transfer data stored in the second external storage device to the second parallel processing device, without an intervention of the I/O controller or the main memory.

Moreover, the present invention solves the above problem by providing,

a non-transitory computer readable medium according to Paragraph 0015,

wherein the first external storage device, the first parallel processing device, the first I/O switch are housed in an off-the-shelf external I/O expansion unit.

Moreover, the present invention solves the above problem by providing

a non-transitory computer readable medium according to Paragraph 0015 or Paragraph 0016,

wherein the first I/O switch and the I/O controller is connected using a PCIe interface.

Moreover, the present invention solves the above problem by providing

a non-transitory computer readable medium according to Paragraph 0015 or Paragraph 0016,

wherein the first I/O switch and the I/O controller is connected using a network.

Moreover, the present invention solves the above problem by providing

a non-transitory computer readable medium according to Paragraph 0015, Paragraph 0016, Paragraph 0017 or Paragraph 0018, further comprising instructions for:
rewriting an SQL query so that an internal join operation to a table spanning the first external storage device and the second external storage device is executed in preference.

Moreover, the present invention solves the above problem by providing

a computer-executable database processing method executed on a database processing system,

the database processing system comprising:
a first external storage device;
a first parallel processing device;
a first I/O switch;
a second external storage device;
a second parallel processing device;
a second I/O switch;
a central processing unit;
an I/O controller which is built in the central processing unit or directly connected to the central processing unit via an internal bus; and
a main memory;
wherein the first external storage device, a first parallel processing device, and a first I/O switch are housed in a first enclosure;
the second external storage device, the second parallel processing device and the second I/O switch are housed in a second enclosure;
the central processing unit and the I/O controller are housed in a third enclosure;
the first enclosure and the third enclosure are different;
the second enclosure and the third enclosure are different, the computer-executable database processing method comprising:
ordering, to the first external storage device via the first I/O switch, to transfer data stored in the first external storage device to the first parallel processing device, without an intervention of the I/O controller or the main memory; and
ordering to the second external storage device via the second I/O switch, to transfer data stored in the second external storage device to the second parallel processing device, without an intervention of the I/O controller or the main memory.

Moreover, the present invention solves the above problem by providing

a computer-executable method according to Paragraph 20,

wherein the first external storage device, the first parallel processing device and the first I/O switch are housed in an off-the-shelf external I/O expansion unit.

Moreover, the present invention solves the above problem by providing

a computer-executable method according to Paragraph 20 or Paragraph 21,

wherein the first I/O switch and the I/O controller is connected using a PCIe interface.

Moreover, the present invention solves the above problem by providing

a computer-executable method according to Paragraph 20 or Paragraph 21,

wherein first I/O switch and the I/O controller is connected using a network.

Moreover, the present invention solves the above problem by providing

a computer-executable method according to Paragraph 20, Paragraph 21, Paragraph 22 or Paragraph 23, further comprising:

rewriting an SQL query so that an internal join operation to a table spanning the first external storage device and the second external storage device is executed in preference.

### Advantageous Effect of the Invention

A system, method, and program for improving the efficiency of database queries that can be implemented affordably is provided.

### BRIEF DESCRIPTION OF THE DRAWING

FIG. 1 This figure shows the configuration of a conventional GPU-based database server (prior art).

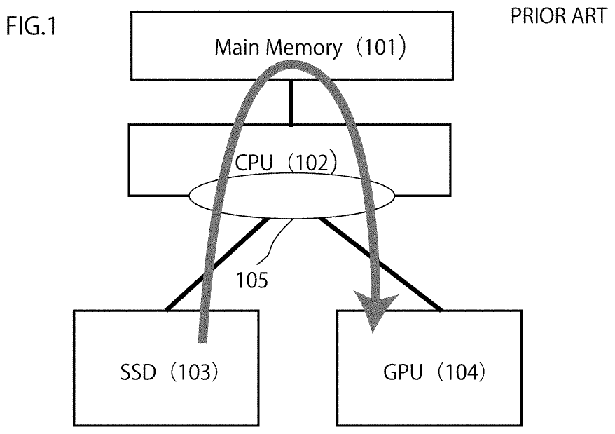

FIG. 2 This figure shows the configuration of a database server using a conventional GPU and P2P DMA (prior art).

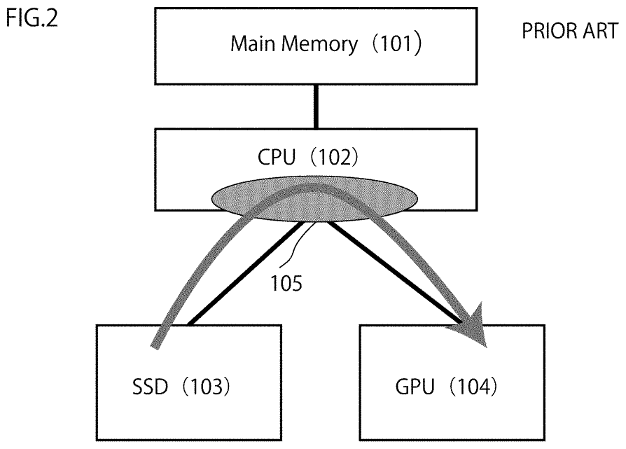

FIG. 3 This figure shows the overall configuration of an embodiment of a database server according to the present disclosure.

FIG. 4 This figure shows the data flow in an embodiment of a database server according to the present disclosure.

FIG. 5 This figure shows the overall structure of an alternative embodiment of a database server according to the present disclosure.

FIG. 6 The figure below shows the functional structure of an embodiment of a database query preprocessing program according to the present disclosure.

FIG. 7 The figure below shows an example of SQL query rewriting by an embodiment of a database query preprocessing program according to the present disclosure.

### DESCRIPTION OF EMBODIMENTS

Embodiments of the present invention will be explained hereafter with reference to figures. All the figures are illustrative.

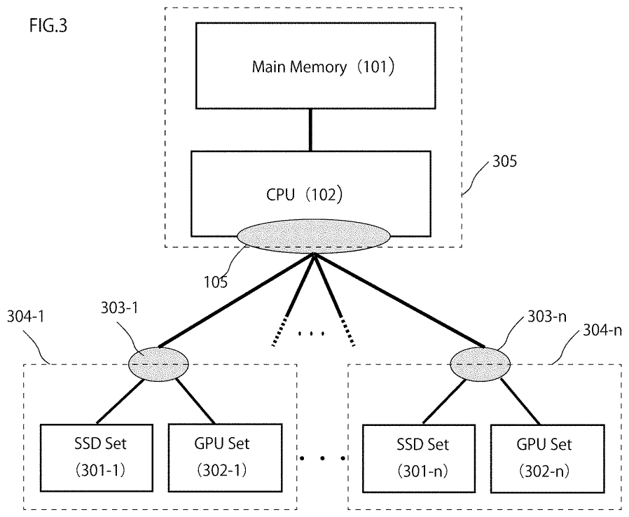

FIG. 3 shows the overall configuration of an embodiment of a database server (database processing system) according to the present disclosure. A main memory (101), a CPU (102), and I/O controller (105) are equivalent to the conventional technology. A plurality of SSD sets (301-1 to 301-n) (wherein n is 2 or more) are means of storing data (such as tables in a database). Each SSD set consists of one or more SSDs (Solid State Drives), while any storage technology other than SSD may be used. A plurality of GPU sets (302-1 to 302-n) (wherein n is 2 or more) are means of processing database data in parallel. Each GPU set consists of one or more GPUs, while other types of parallel processing devices (e.g., field-programmable gate array (FPGA)) or other technologies may be used. Unlike conventional technologies, the I/O controller (105) (hereinafter also referred to as the “CPU-side I/O controller”) that is built in the CPU (101) or directly connected to the CPU (101) via an internal bus (preferably a PCIe Root Complex) is connected to the SSD sets (301-1 to 301-n) via a bus (preferably a PCIe standard bus) and multiple I/O switches (303-1 to 303-n) (preferably PCIe switches). Each I/O switch (e.g., 303-1) has a function (e.g., P2P DMA) to exchange data between SSD sets (301-1) and GPU sets (302-1) in the same enclosure without the intervention of the CPU (102) and the main memory (101).

Here, off-the-shelf I/O expansion units may be used as enclosures (304-1) to house at least some of I/O switches (e.g., 303-1) and their corresponding SSD sets (e.g., 301-1) and GPU sets (e.g., 302-1). An I/O expansion unit is originally a device for extending a PCIe bus to the outside of a server enclosure using cables in order to connect SSDs and GPUs that do not fit in the server enclosure. However, in the present disclosure, it is utilized as a means to improve processing efficiency. By being able to utilize mass-produced off-the-shelf products that are generally available on the market, a database server according to the present disclosure can achieve efficient database processing at a relatively low cost. It is not necessary that only one I/O switch is housed in one I/O expansion unit (enclosure), but more than one I/O switches may be housed in one I/O expansion unit (enclosure). Advantageously, the main memory (101), the CPU (102), and the CPU-side I/O controller (105) are housed in the server enclosure (305).

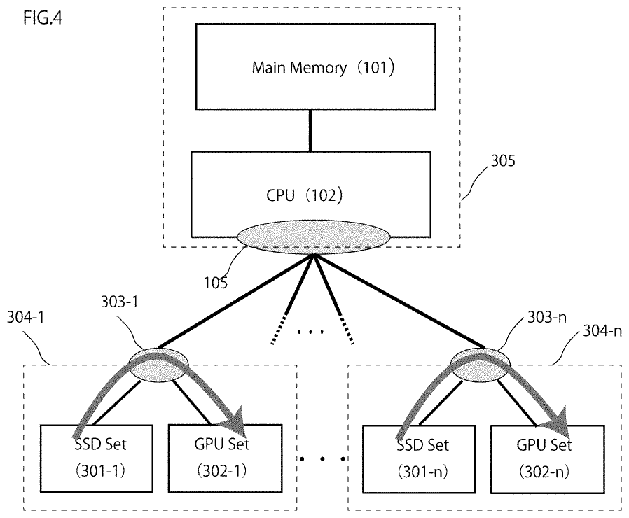

FIG. 4 shows a flow of data in an embodiment of a database server of the present disclosure. As represented by the arrows in FIG. 4, each I/O switch (303-1 to 303-n), according to the instructions of the CPU (102), transfers data (e.g., data in database tables) in SSD sets (301-1 to 301-n) to GPUs in the corresponding GPU sets (302-1 to 302-n) stored in the same enclosure, preferably using P2P DMA technology. The GPU processes the data in parallel and writes back only the results to the main memory (101). Here, if the SSD and GPU are in the same enclosure, the P2P DMA packets do not pass through the CPU's built-in I/O controller (105), so it does not become a bottleneck, improving the overall efficiency of the system.

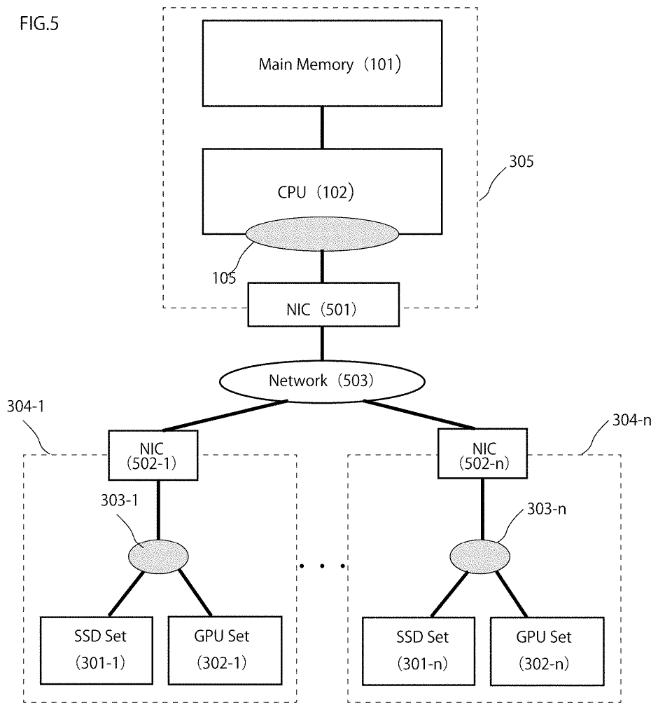

FIG. 5 shows the overall configuration of an alternative embodiment of a database server according to the present disclosure. In this embodiment, I/O bus signals from the CPU's built-in I/O controller (105) are not directly extended to the I/O switches (303-1 to 303-n) but are connected to the NICs (502-1 to 502-n) of the I/O expansion unit via the NIC (network interface card) (501) in the host a network (503). The network (503) may be a LAN (Local Area Network), SAN (Storage Area Network), or WAN (Wide Area Network) and so on. This embodiment is advantageous in increased flexibility in equipment placement. For a type of processing where the GPU reads and processes a large amount of data from the SSD and outputs a small amount of data, it can efficiently perform large-scale processing without being greatly affected by a bandwidth and a latency of the network (503).

As mentioned above, a database processing apparatus according to the present disclosure can improve efficiency when the data in SSDs can be processed by GPUs in the corresponding GPU set in the same enclosure (e.g., data in SSD set (301-3) is processes by GPU set (302-3)). In order to achieve this goal, it is preferable that the database server of the present application runs a program that rewrites SQL in order to improve the efficiency of database queries.

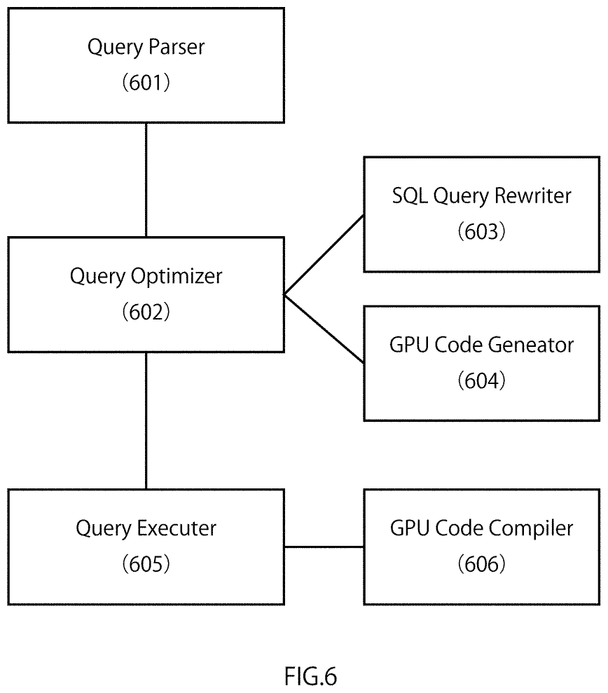

FIG. 6 shows a functional configuration of an embodiment of a database query processing program according to the present disclosure. A query parser (601) provides a function to parse the query syntax of the input SQL statements. A query optimizer (602) provides, in addition to general SQL query optimization, a function to optimize SQL queries to suite the hardware configuration of the database processing apparatus according to the present disclosure. A query optimizer (602) comprises a SQL query rewriter (603) and a GPU code generator (604). The process of the SQL query rewriter (603) will be explained later. The GPU code generator (604) provides a function to generate code executed on each GPU based on the rewritten queries. A query executer (605) provides a function to execute SQL query statements on each GPU and includes a GPU code compiler (606) which generates GPU code s executable by the GPU.

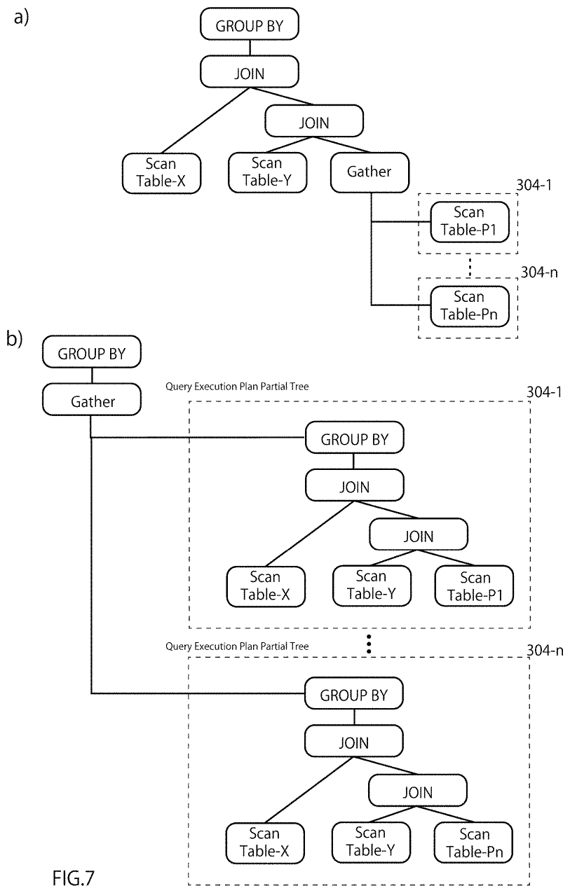

FIG. 7 shows an example of SQL query rewriting by an embodiment of a database query preprocessing program (SQL query rewriting section (603)). FIG. 7-a) shows the query execution plan before rewriting, and FIG. 7-b) shows the query execution plan after rewriting. Here, we take the internal join (JOIN) process of table X, table Y, and table P as an example. Assume that the data in table P is divided and stored in multiple (n) SSD sets (103-1 to 103-n), and that the data in table X and table Y are stored in duplicate in each SSD set (103-1 to 103-n). Because the distributive law is valid for internal join operations, the final result is the same whether 1) JOIN between table X and table Y is performed after the scanning process for the entire table P; or 2) JOIN among table P, table X, and table Y on each SSD set (103-1 to 103-n) is performed first and then the intermediate results are aggregated (GATHER operation). The latter (2) approach minimizes the load on the CPU (102) and main memory (101) because most of the processing will be completed within the same I/O expansion unit (402).

The following is a generalized description of the process of database query preprocessing programs according to the present disclosure. Before or during Query Optimizer (602) creates a query execution plan, if SQL Query Rewriter (603) discovers (e.g., based on database metadata) a plurality of database tables that span across SSDs on multiple I/O expansion units, then SQL Query Rewriter (603) rewrites the query to perform JOIN and GROUP BY processing with other tables before aggregating (gathering) data read from some of the tables on each SSD. This makes it possible to execute multiple processes in parallel within each I/O expansion unit without transferring large amount of data to the CPU or the main memory. It is especially effective for JOIN operations, which generally require a high CPU load and GROUP BY operations, which can drastically reduce the amount of data when executed first.

Query Rewriter (603) produces a query execution plan subtree, (a part of a query execution plan) after it rewrites the query. If the query execution plan subtree is identified, based on information such as database metadata, being optimal for execution in a specific I/O expansion unit (107), then a GPU in the GPU set (302) in that specific I/O expansion unit is selected to execute that query.

When Query Executer (605) executes a scan operation (and its subsequent JOIN and GROUP BY operations), it issues instructions (orders) (via I/O switches) to the SSDs in the SSD set (301) to perform P2P DMA transfers to the GPUs in the GPU set (302) that were selected in the process of generating the query execution plan subtree mentioned above. An SSD in the SSD set (301) executes the instruction and starts data transfer to a GPU in the GPU set (302) in the same I/O expansion unit (304), and an I/O switch (303) in the same I/O expansion unit (304) forwards the data to a GPU in the GPU set (302) in the same expansion unit (304) without passing data packet to the CPU-side I/O controller (105). Query Executer (605) executes these processes in parallel for each of the I/O expansion units (304). This enables efficient execution of large database query processing while minimizing the consumption of resources of the main memory (101), the CPU (102), the CPU-side I/O controller (105), and the host system bus bandwidth.

### TECHNOLOGICALLY SIGNIFICANT EFFECTS OF THE PRESENT INVENTION

First, data transfer between secondary storage devices such as SSDs and the GPU (parallel processing device), which would be the most critical bottleneck, can be completed only inside the I/O expansion unit, thus reducing the amount of data received by the I/O controller. This makes it possible to process data with a throughput that exceeds the original bandwidth of the I/O bus, resulting in further performance improvements in secondary storage devices in the future. Second, since the GPU processes SQL, and only the necessary data is transferred to the main memory after data have been reduced in advance, it is possible to reduce the consumption of the main memory and allocate memory for other uses. Third, by using I/O expansion units to add secondary storage devices and sub-computing devices outside the database server, it is possible to easily add devices as the database size increases, without having to adopt a configuration with plenty of room from the initial stage. This will reduce the initial investment in hardware and improve the cash flow of system investment.

1. A database processing apparatus comprising:
a database processing apparatus comprising:
a first external storage device;
a first parallel processing device;
a first I/O switch;
a second external storage device;
a second parallel processing device;
a second I/O switch;
a central processing device;
an I/O controller which is built in the central processing unit or directly connected to the central processing unit via an internal bus; and
a main memory;
wherein the first external storage device, a first parallel processing device, and a first I/O switch are housed in a first enclosure;
the second external storage device, the second parallel processing device, and the second I/O switch are housed in a second enclosure;
the central processing unit and the I/O controller are housed in a third enclosure;
the first enclosure and the third enclosure are different;
the second enclosure and the third enclosure are different;
the central processing unit is configured to issue, to the first external storage device via the first I/O switch, an order for transferring data stored in the first external storage device to the first parallel processing device, without an intervention of the I/O controller or the main memory; and
the central processing unit is configured to order, to the second external storage device via the second I/O switch, an instruction for transferring data stored in the second external storage device to the second parallel processing device, without an intervention of the I/O controller or the main memory.

2. A database processing apparatus according to claim 1,
wherein the first external storage device, the first parallel processing device and the first I/O switch are housed in an off-the-shelf external I/O expansion unit.

3. A database processing apparatus according to claim 1, wherein the first I/O switch and the I/O controller is connected using a PCIe interface.

4. A database processing apparatus according to claim 1, wherein the first I/O switch and the I/O controller is connected using a network.

5. a non-transitory computer readable medium that stores a computer-executable program for database processing,
the computer-executable program being executed on a database processing apparatus comprising:
a first external storage device;
a first parallel processing device;
a first I/O switch;
a second external storage device;
a second parallel processing device;
a second I/O switch;
a central processing unit;
an I/O controller which is built in the central processing unit or directly connected to the central processing unit via an internal bus; and
a main memory;
wherein the first external storage device, a first parallel processing device, and a first I/O switch are housed in a first enclosure;
the second external storage device, the second parallel processing device and the second I/O switch are housed in a second enclosure;
the central processing unit and the I/O controller are housed in a third enclosure;
the first enclosure and the third enclosure are different;
the second enclosure and the third enclosure are different, and
the computer-executable program comprising instructions for:
ordering, to the first external storage device via the first I/O switch, to transfer data stored in the first external storage device to a first parallel processing device, without an intervention of the I/O controller or the main memory; and
ordering to the second external storage device via the second I/O switch, to transfer data stored in the second external storage device to the second parallel processing device, without an intervention of the I/O controller or the main memory.

6. A non-transitory computer readable medium according to claim 5,
wherein the first external storage device, the first parallel processing unit and the first I/O switch are housed in an off-the-shelf external I/O expansion unit.

7. A non-transitory computer readable medium according to claim 5,
wherein the first I/O switch and the I/O controller is connected using a PCIe interface.

8. A non-transitory computer readable medium according to claim 5,
wherein the first I/O switch and the I/O controller is connected using a network.

9. A non-transitory computer readable medium according to claim 5, further comprising instructions for:
rewriting an SQL query so that an internal join operation to a table spanning the first external storage device and the second external storage device is executed in preference.

10. a computer-executable database processing method executed on a database processing system,
the database processing system comprising:
a first external storage device;
a first parallel processing device;
a first I/O switch;
a second external storage device;
a second parallel processing device;
a second I/O switch;
a central processing unit;
an I/O controller which is built in the central processing unit or directly connected to the central processing unit via an internal bus; and
a main memory;
wherein the first external storage device, a first parallel processing device, and a first I/O switch are housed in a first enclosure;
the second external storage device, the second parallel processing device and the second I/O switch are housed in a second enclosure;
the central processing unit and the I/O controller are housed in a third enclosure;
the first enclosure and the third enclosure are different;
the second enclosure and the third enclosure are different,
the computer-executable database processing method comprising:
ordering, to the first external storage device via the first I/O switch, to transfer data stored in the first external storage device to the first parallel processing device, without an intervention of the I/O controller or the main memory; and
ordering to the second external storage device via the second I/O switch, to transfer data stored in the second external storage device to the second parallel processing device, without an intervention of the I/O controller or the main memory.

11. A computer-executable method according to claim 10,
wherein the first external storage unit, the first parallel processing unit and the first I/O switch are housed in an off-the-shelf external I/O expansion unit.

12. A computer-executable method according to claim 10, wherein the first I/O switch and the I/O controller is connected using a PCIe interface.

13. A computer-executable method according to claim 10, wherein first I/O switch and the I/O controller is connected using a network.

14. A computer-executable method according to claim 10, further comprising:
rewriting an SQL query so that an internal join operation to a table spanning the first external storage device and the second external storage device is executed in preference.
